(19) United States
(12) Patent Application Publication
(10) Pub. No.: US 2014/0136151 A1
(43) Pub. Date: May 15, 2014

(54) Methods and Systems for Generating Continuous Surfaces from Polygonal Data

(71) Applicants: Gary Arnold Crocker, San Diego, CA (US); Wei-En Ting, San Diego, CA (US)

(72) Inventors: Gary Arnold Crocker, San Diego, CA (US); Wei-En Ting, San Diego, CA (US)

(21) Appl. No.: 13/673,944

(22) Filed: Nov. 9, 2012

(51) Int. Cl. G06F 17/50

(52) U.S. Cl. CPC G06F 17/50
USPC 703/1

(57) ABSTRACT

Methods and systems for generating surface data from polygonal data are disclosed. The methods and systems receive polygonal data which describe geometries in a mesh. The methods and systems analyze and use the polygonal data to calculate and define a continuous BREP object which accurately represents the original polygonal object.

### BACKGROUND

1. Field

The described technology relates to systems and methods of generating continuous surfaces from data of a polygonal model.

2. Description of the Related Technology

Polygonal model data may be created with, for example, a scanning software tool by. The polygonal model or polygonal mesh includes discrete data points describing one or more surfaces or objects. Polygonal models are convenient for design work at least because they define the surface or object at a degree of detail convenient for the designer to work with. The shape of the surface or object is defined by the data points, and the surface between the data points is perceived, but is not represented in the data. This allows for the CAD system to function quicker because of a significantly reduced data set representing the surface or object, while providing the designer enough detail to manipulate to achieve a desired design.

Once the designer has finished the design, the polygonal data can be used, for example, as the basis for manufacturing a physical object or for generating an image of the designed object. To manufacture the object, or analyze it, or to generate the image, the mesh data is often not sufficient. For a physical object or a realistic image, a BREP object containing one or more surfaces must be defined. The surfaces are preferably Non-uniform rational B-spline (NURBS). NURBS is a mathematical model commonly used to represent curves and surfaces, which are either analytic or freeform. A BREP (Boundary REPresentation) may be understood to be a geometric and topological representation used, for example, in CAD applications that links together curves and surfaces to form either a solid (closed volume) or a shell (open).

For accurate CAD models, the continuity of the interior surface and the continuity between adjacent surfaces are important characteristics of the final product. Mathematically, for adjoining surfaces, continuity grades of G1 and G2 are defined. Each point on the final BREP object is a point on one or more surfaces. The continuity of the two surfaces at a point where they touch is characterized as G1 if the surfaces share a common tangent plane at the point. The continuity of two surfaces at the point is characterized as G2 if the surfaces share both a common tangent plane and common curvature at the point. For high quality surfaces G2 continuity at most points on the BREP object is highly desirable in terms of design aesthetics and manufacturability.

### SUMMARY OF CERTAIN INVENTIVE ASPECTS

One aspect includes a method of producing BREP data from electronic polygonal data. The method includes accessing the polygonal data with a computer, the polygonal data defining a mesh comprising a plurality of geometries, designating a plurality of geometries as seed geometries, and defining a plurality of seed regions, each containing one of the seed geometries. The method also includes expanding the seed regions so that each of the geometries of the mesh are included in one of the seed regions, generating the BREP data based at least in part on the seed regions, and storing the BREP data in a computer readable data storage.

Another aspect includes a computer system configured to access polygonal data defining a mesh comprising a plurality of geometries. The computer system is also configured to designate a plurality of geometries as seed geometries, and to define a plurality of seed regions, each containing one of the seed geometries. The computer system is also configured to expand the seed regions so that each of the geometries of the mesh are included in one of the seed regions, to generate the BREP data based at least in part the seed regions, and to store the BREP data in a computer readable data storage.

Another aspect includes a computer readable medium comprising non-transient instructions, which, when executed, cause the computer to perform a method of producing BREP data from electronic polygonal data. The method includes accessing the polygonal data with a computer, the polygonal data defining a mesh comprising a plurality of geometries, designating a plurality of geometries as seed geometries, and defining a plurality of seed regions, each containing one of the seed geometries. The method also includes expanding the seed regions so that each of the geometries of the mesh are included in one of the seed regions, generating the BREP data based at least in part on the seed regions, and storing the BREP data in a computer readable data storage.

Another aspect includes a programmable device configured to access polygonal data defining a mesh comprising a plurality of geometries. The programmable device is also configured to designate a plurality of geometries as seed geometries, and to define a plurality of seed regions, each containing one of the seed geometries. The programmable device is also configured to expand the seed regions so that each of the geometries of the mesh are included in one of the seed regions, to generate the BREP data based at least in part the seed regions, and to store the BREP data in a computer readable data storage.

### BRIEF DESCRIPTION OF THE DRAWINGS

FIG. 1 is a graphical illustration of polygonal data.

FIG. 2 is a graphical illustration of continuous BREP object data generated from the polygonal data of FIG. 1.

FIG. 3 is an illustration of the polygonal data 1 shown in FIG. 1, having seed geometries highlighted.

FIGS. 4A and 4B illustrate an embodiment of seed region expansion.

FIG. 5 illustrates seed regions based on the seed geometries of FIG. 3.

FIG. 6 illustrates seed regions after a second iteration of the seed region generation process.

FIG. 7 illustrates the seed regions after four iterations of the seed region generation process.

FIG. 8 illustrates the data of FIG. 7 with the seed regions smoothed.

FIG. 9 illustrates the results of the seed region generation process.

FIG. 10 is a graphical illustration of continuous BREP object generated from the polygonal data 1 of FIG. 1 based on the boundaries of the seed regions of FIG. 9.

### DETAILED DESCRIPTION OF CERTAIN INVENTIVE EMBODIMENTS

Various aspects and features of methods and systems are described herein with reference to the accompanying drawings, which show certain exemplary embodiments. The described embodiments may be modified in various ways, without departing from the spirit or scope of the present invention. In addition, the described embodiments have multiple features and aspects, no single one of which is solely responsible for the desirable characteristics thereof. Furthermore, no single feature or aspect is essential to practicing the methods and systems described herein. Furthermore, various features and aspects of the embodiments may be combined in embodiments not specifically described.

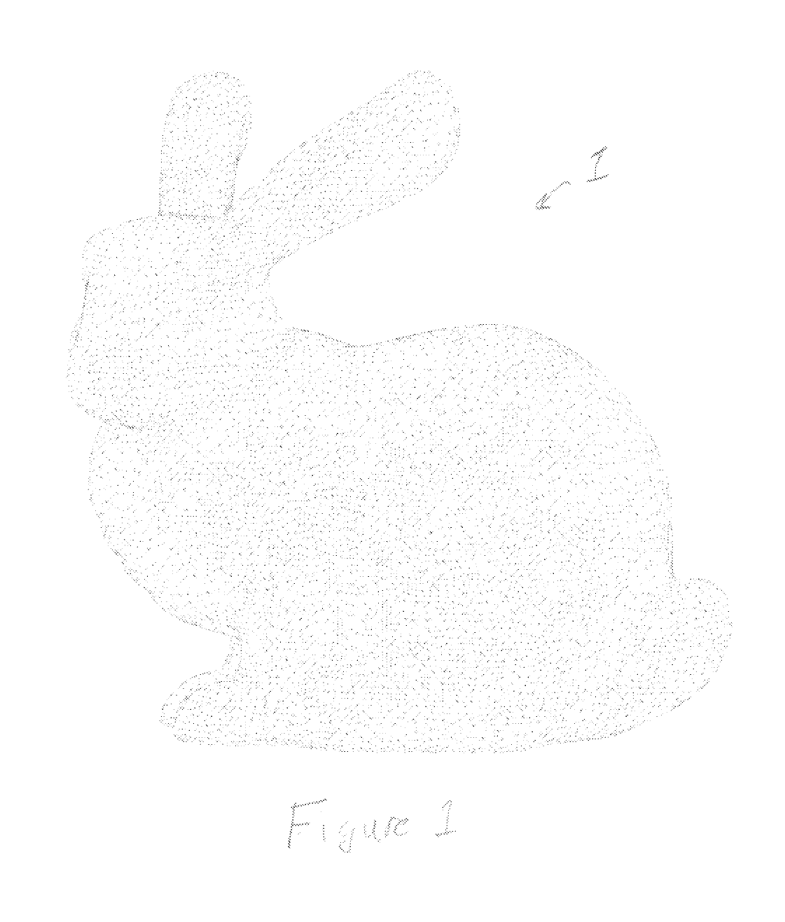

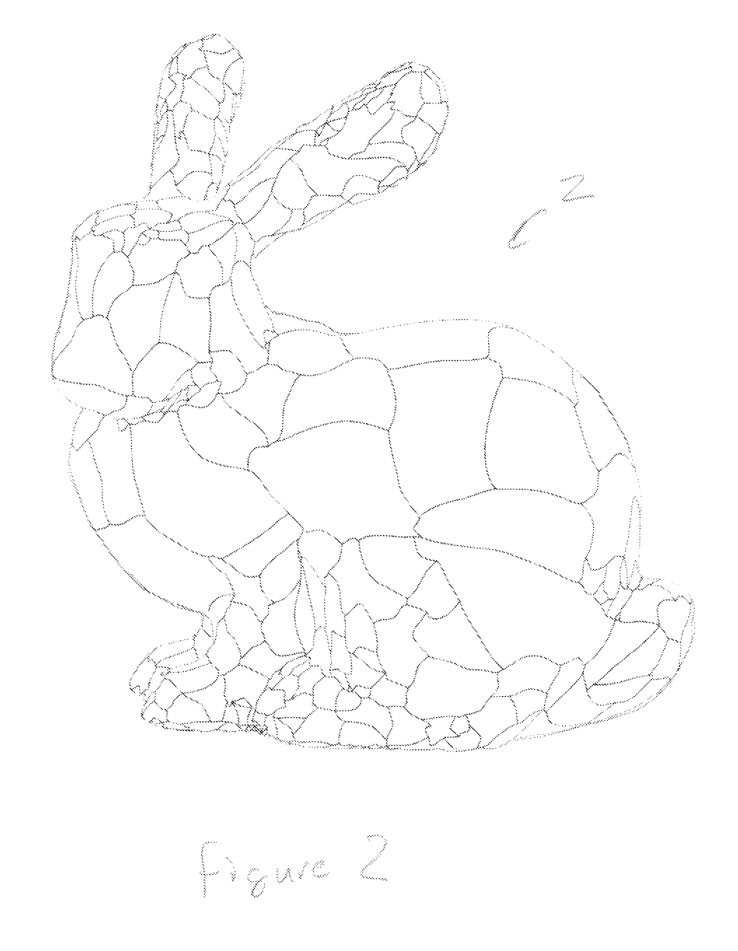

Various inventive aspects of certain embodiments of methods and systems for generating BREP object data from polygonal data are discussed. The methods and systems receive polygonal data which describe discrete points on an object. The methods and systems analyze and use the data to calculate and define a BREP object which accurately represents the polygonal object. For example, the methods and systems may receive polygonal data 1, such as that represented in FIG. 1 and generate a BREP object 2, such as that represented in FIG. 2. Among other beneficial aspects, in some embodiments, the BREP object defined by the methods and systems interpolates all or substantially all of the points in the polygonal data. In some embodiments, the BREP object defined by the methods and systems include all or substantially all of the points in the polygonal data. The methods and systems reliably define BREP objects for polygonal data of a wide variety of polygonal data. While triangular polygonal data is used in the described embodiments, quadrilateral polygonal data may be effectively used. The BREP objects produced may contain mostly naturally trimmed (rectangular bounded) surfaces with a layout similar to what might be created by a designer in a CAD system. The flow lines of the resulting BREP curves and surfaces may closely match the flow lines of the original data mesh. Surfaces may be roughly rectangular, two manifold, and/or curved. Additionally, surfaces can be of any type, for example, NURBS surface, Bezier surface, Coons surface, Gregory Patch, etc.

A polygonal model or polygonal mesh can be characterized as being, for example, triangular or quadrilateral. In a predominantly triangular mesh, the polygons defined by the data are generally triangular. In a predominantly triangular mesh most polygons are defined by three data points. FIG. 1 shows polygonal data 1, which is a predominantly triangular mesh.

In some embodiments, methods and systems receive polygonal data representing an object. FIG. 1 shows an example of such data, and FIG. 2 shows an example of a continuous BREP object 2 corresponding to the surface represented by the polygonal data 1 shown in FIG. 1. In order to generate the continuous BREP object 2, in some embodiments, the polygonal data 1 is analyzed and continuous surfaces are formed. The collection of continuous surfaces corresponds to the BREP object 2 represented by the polygonal data 1, where each surface corresponds to a unique portion of the BREP object 2 represented by the polygonal data 1. Each of the continuous surfaces forms a portion of the continuous BREP object 2.

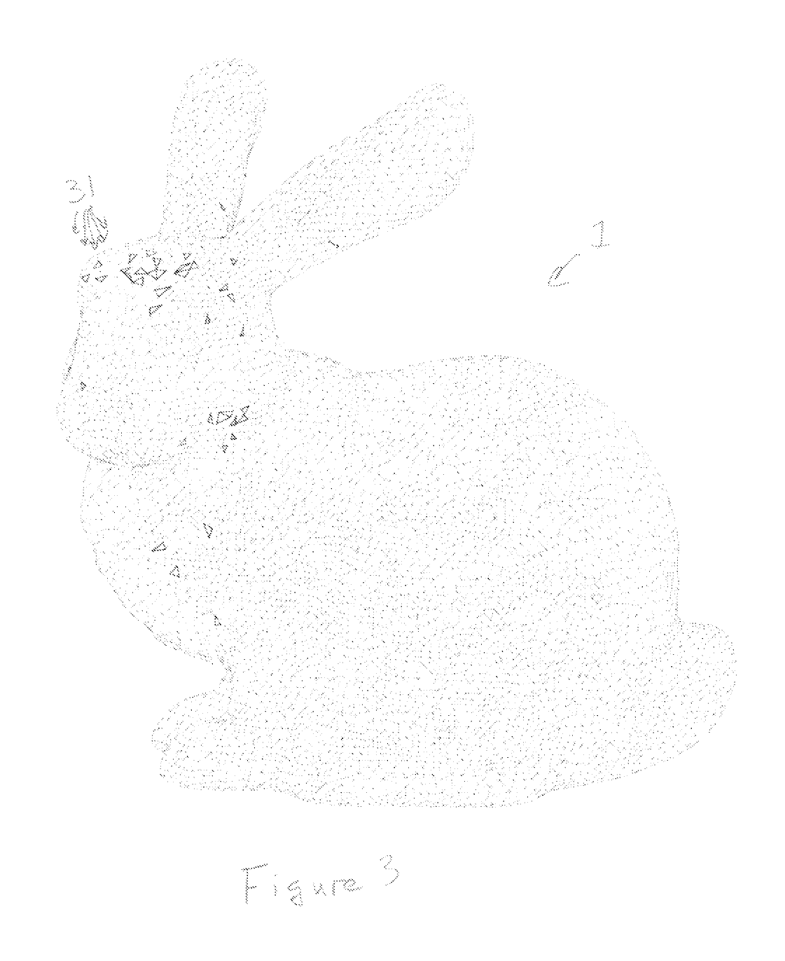

FIG. 3 is an illustration of the polygonal data 1 shown in FIG. 1, having certain geometries highlighted. The methods and systems operate on the polygonal data 1 using the highlighted faces 31 as seed geometries 31. The seed geometries 31, may, for example, be vertices, lines, or faces. For purposes of discussion only, the methods and systems discussed herein use seed geometries 31 which are faces. Other implementations may use other geometry types or combinations of geometry types.

In some embodiments, the user provides the system an indication defining which of the geometries are to be the seed geometries. In some embodiments, a quantity of seed geometries may be determined, for example, by user input. For example, if a user determines or estimates that the resulting BREP model should contain a certain number of surfaces, the user may input that number to the system. In response, the system selects that number of seed geometries. In some embodiments, the system determines the number of seeds, for example, by dividing the number of geometries in the polygonal data by a constant number, such as 4000.

The system may, for example, place the seed geometries so that the distance between the seed geometries is about equal. Because the methods and systems may iteratively adjust the placement of the seed geometries, in some embodiments, it may be beneficial to randomly select the seed geometries. In some embodiments, every nth geometry is identified as a seed geometry. For example, each geometry typically has a unique identifier or index. If, for example, one seed geometry is to be selected for every 4,000^{th} geometry, the systems and methods select, for example, the geometries having index 1, 4,001, 8,001, 12,001, etc. Other methods of seed geometry placement may be used.

Using methods discussed in more detail below, seed regions are generated based on the seed geometries. In some embodiments, starting from the seed geometries, the seed regions are expanded by, for example, one additional geometry at a time. In some embodiments, the methods and systems repeatedly select a next geometry to include in one of the expanding seed regions. Examples of selecting each and assigning the next geometry to one of the seed regions are discussed in more detail below.

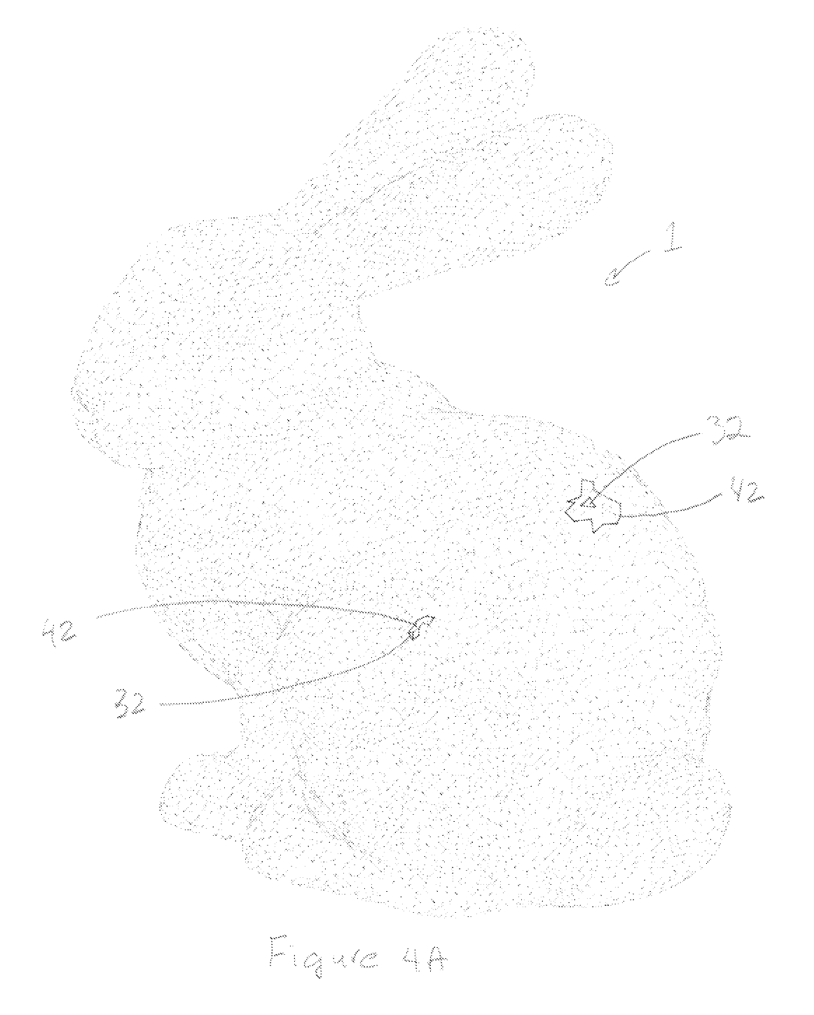

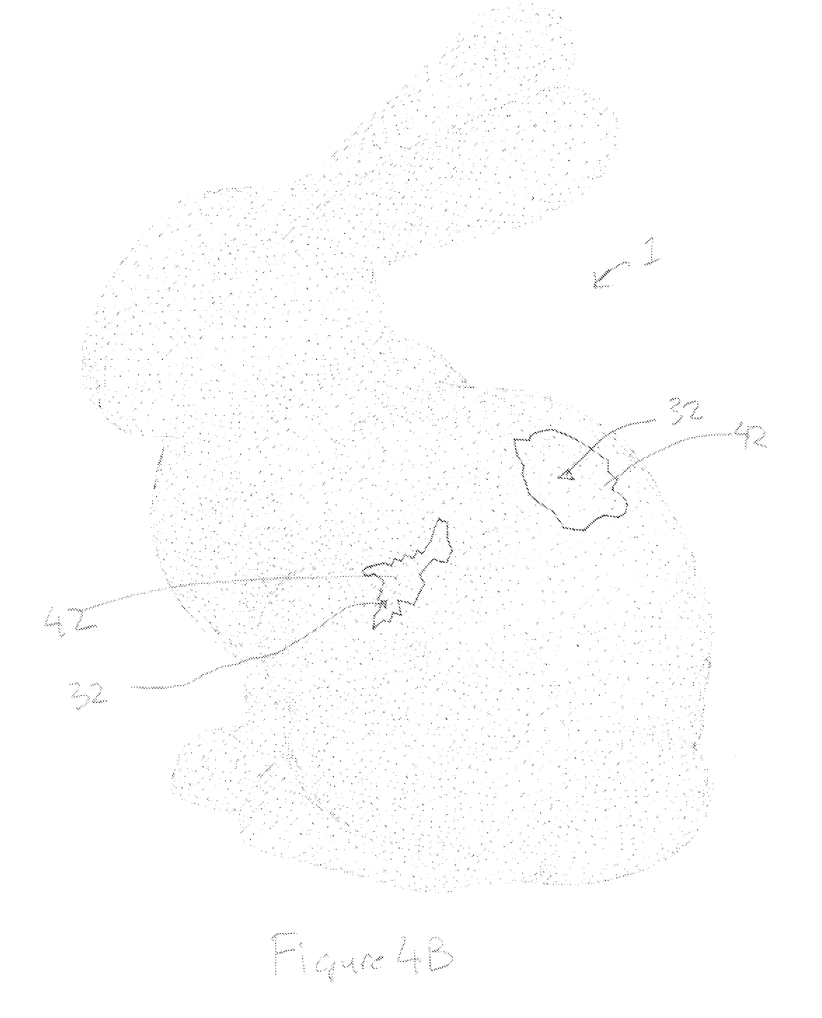

FIGS. 4A and 4B illustrate an embodiment of seed region expansion. FIG. 4A is an illustration of the polygonal data 1, having seed regions 42, which have been expanded from seed geometries 32. As shown in this example, each of the seed regions 42 are continuous and each includes one of the seed geometries 32 as well as other geometries. FIG. 4B is an illustration of the polygonal data 1, where the seed regions 42 have been further expanded.

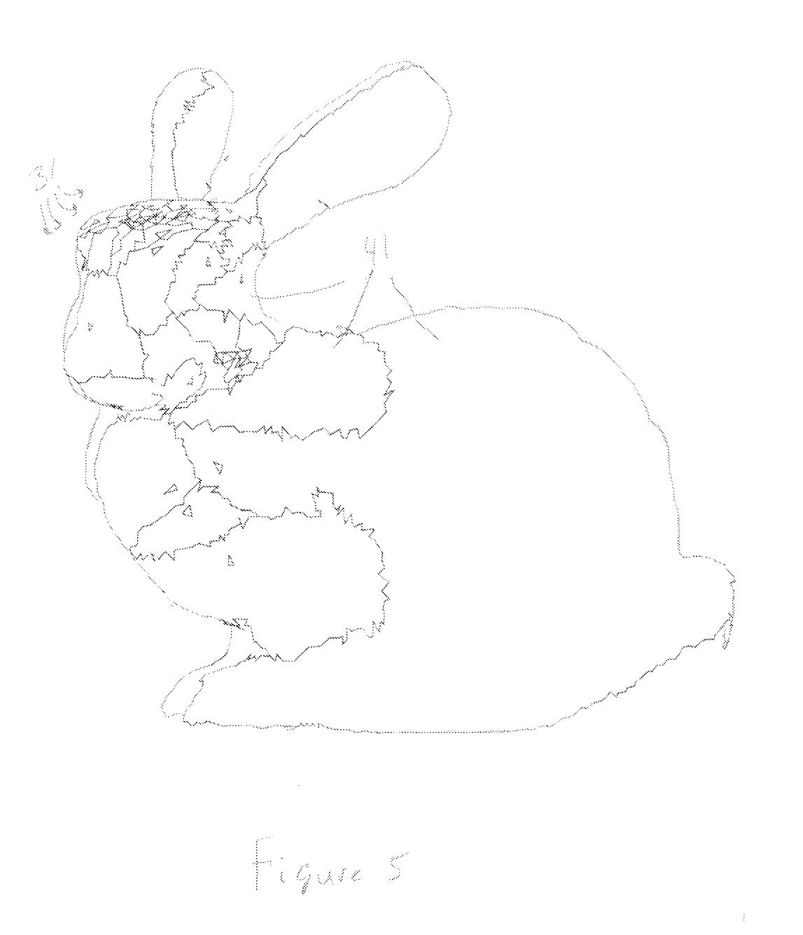

FIG. 5 is an illustration of the polygonal data 1, having seed regions 41 based on seed geometries 31 of FIG. 3, which have been expanded so that every face of polygonal data 1 has been assigned to one of the seed regions 41.

In some embodiments, the systems and methods described herein determine whether the number of seed geometries is adequate. If the number is not adequate, the number of seed geometries is increased or decreased, and new seed regions are determined, for example, using a process such as that described above.

In some embodiments, the determination regarding whether the number of seed geometries is adequate is based on a determination of how parallel the geometries within each of the seed regions are. As an example, an angle between the seed geometry and the other geometries of each seed region may be determined, for example, by comparing directions of normal vectors of the seed geometries with the directions of the normal vectors of the other geometries within each seed region.

In some embodiments, the determination regarding whether the number of seed geometries is adequate is based on a determination of how parallel the geometries within each of the seed regions are with respect to a surface fit to the seed region. As an example, an angle between the normal vector of each geometry of the seed region and a normal vector taken from a point nearest each geometry on a surface fit to the adjacent seed region is compared with a threshold. If an average or a maximum deviation from parallel is greater than the threshold, such as about 10 degrees, the number of seed geometries may be determined to be too few. Likewise, if the average or maximum deviation from parallel is less than a threshold, such as about 10 degrees, the number of seed geometries may be determined to be too many.

If the number of seed geometries is determined to be too few, the number of seed geometries may be increased, and new seed regions are determined, for example, using a process such as that described above. In some embodiments, the number of seed geometries is doubled, and new seed regions are determined.

After each determination of new seed regions, the adequacy of the number of seed geometries (or seed regions) is determined, for example, using a process such as that described above. If, for example, the initial number of seed regions is too few, the number of seed regions may be doubled until the number of seed regions is too many. Once the change from too few to too many occurs, a number of seeds with which to continue may be determined. For example, either the number which is too many or the last number which is too few may be used. In some embodiments, a number between the number which is too many and the last number which is too few is used. For example, an number which is an average or a logarithmic average or center of the number which is too many and the last number which is too few is used. In some embodiments, the last number which is too few is used.

If the number of seed geometries is determined to be too many, the number of seed geometries may be decreased, and new seed regions are determined, for example, using a process such as that described above. In some embodiments, the number of seed geometries is halved, and new seed regions are determined.

After each determination of new seed regions, the adequacy of the number of seed geometries (or seed regions) is determined, for example, using a process such as that described above. If, for example, the initial number of seed regions is too many, the number of seed regions may be halved until the number of seed regions is too few. Once the change from too many to too few occurs, a number of seeds with which to continue may be determined. For example, either the number which is too few or the last number which is too many may be used. In some embodiments, a number between the number which is too few and the last number which is too many is used. For example, a number which is an average or a logarithmic average or center of the number which is too few and the last number which is too many is used. In some embodiments, the number which is too few is used.

The method of determining the number of seed geometries is not limited and numerous other methods not described may be used. In addition, in some embodiments, the number of seed geometries at this point in the process is very flexible, as the process may add or remove seed geometries where a better result would occur.

Once the number of seed geometries is determined, if the determined number of seed geometries is different from a number already used to determine seed regions, new seed regions are determined using the different number. In some embodiments, if the number of seed geometries is equal to a number previously used to determine seed regions, the process may continue with the results of that determination.

Once seed regions are determined with an adequate number of seed geometries, the systems and methods described herein determine whether to generate a BREP object based on the determined seed regions 41 or to generate new seed regions based on the determined seed regions 41. In some embodiments, if new seed regions are to be generated, another seed region generation iteration is performed, for example, by selecting new seed geometries and generating new seed regions based on the new seed geometries using, for example, the method described above or another method. In some embodiments, the new seed geometries are selected as the center or centermost geometries of each of the determined seed regions 41.

In some embodiments, the determination whether to perform a next iteration is made based on a fixed number of iterations of the seed region generation process. For example, in some embodiments, the methods and systems are defined or programmed to execute 1, 2, 3, 4, 5, 6, 7, 8, 9, or 10 iterations. The number of iterations may be controlled, for example, by user input. Alternatively the methods and systems may determine whether to perform a next iteration based at least in part on an analysis of a completed iteration. For example, the result of the last iteration may be compared with the result of an iteration previous to the last iteration, and if the difference between the results of the last and the previous iterations is less than a threshold, no further iterations are performed. In some embodiments the results which are compared may include, for example, the size or the regions, the shape of the regions, or the center of the regions. In some embodiments, after each iteration, distances between each seed geometry and the center geometry of the corresponding seed region are used to determine whether to perform a next iteration. For example, if the average or the maximum of the distances is less than a threshold no further iterations are performed.

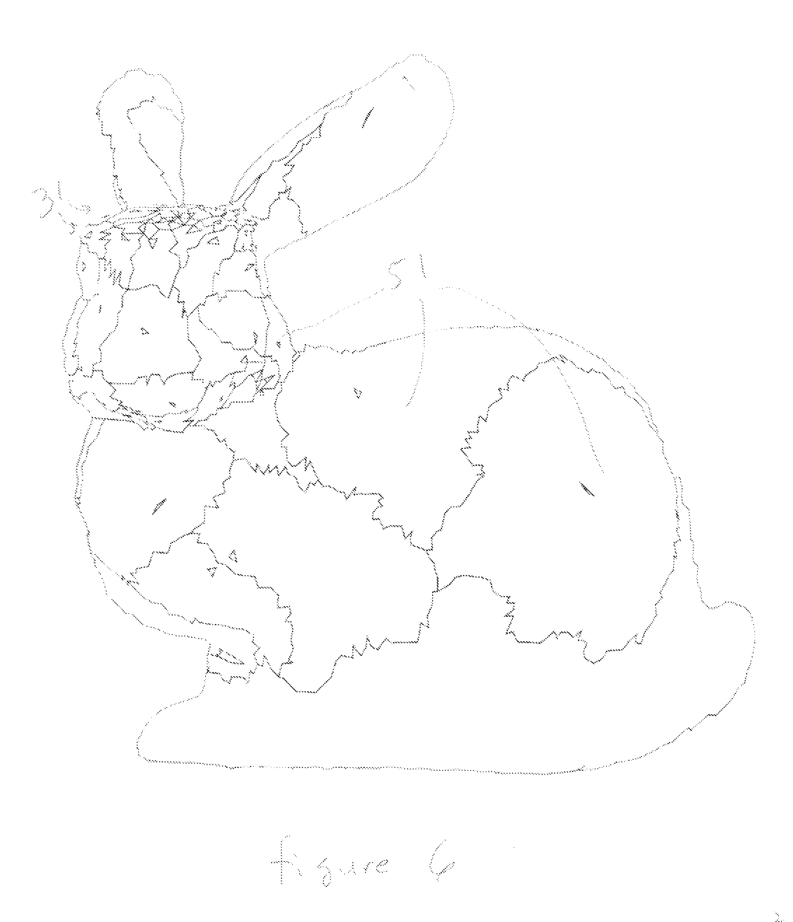

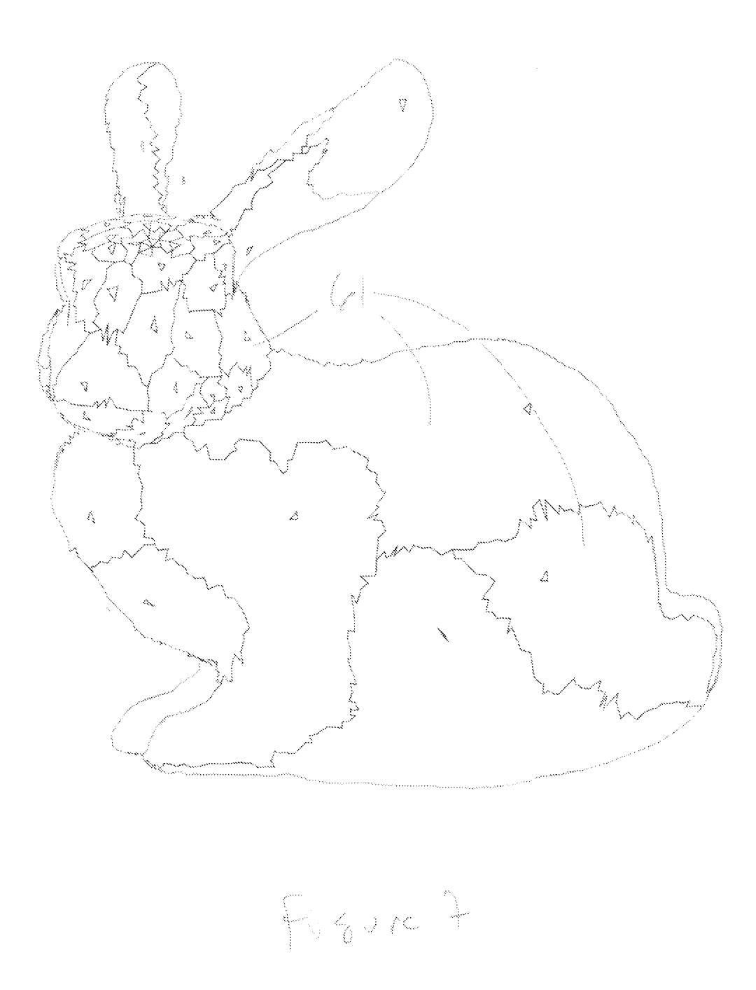

FIG. 5 shows the seed regions 41 after a single iteration of the seed region generation process described above. FIG. 6 shows the seed regions 51 after a second iteration of the seed region generation process. As shown, the seed regions 51 are more uniform, more evenly distributed and are more planar than seed regions 41. For example, the seed regions 51 are more uniform, more evenly distributed and are more planar than seed regions 41. FIG. 7 shows the seed regions 61 after four iterations of the seed region generation process described above. As shown, the seed regions 61 are more uniform, more evenly distributed and are more planar than seed regions 51, and the seed geometries 31 of FIG. 7 are near the centers of seed regions 61, whereas the seed geometries 31 of FIG. 5 are less near the centers of seed regions 41.

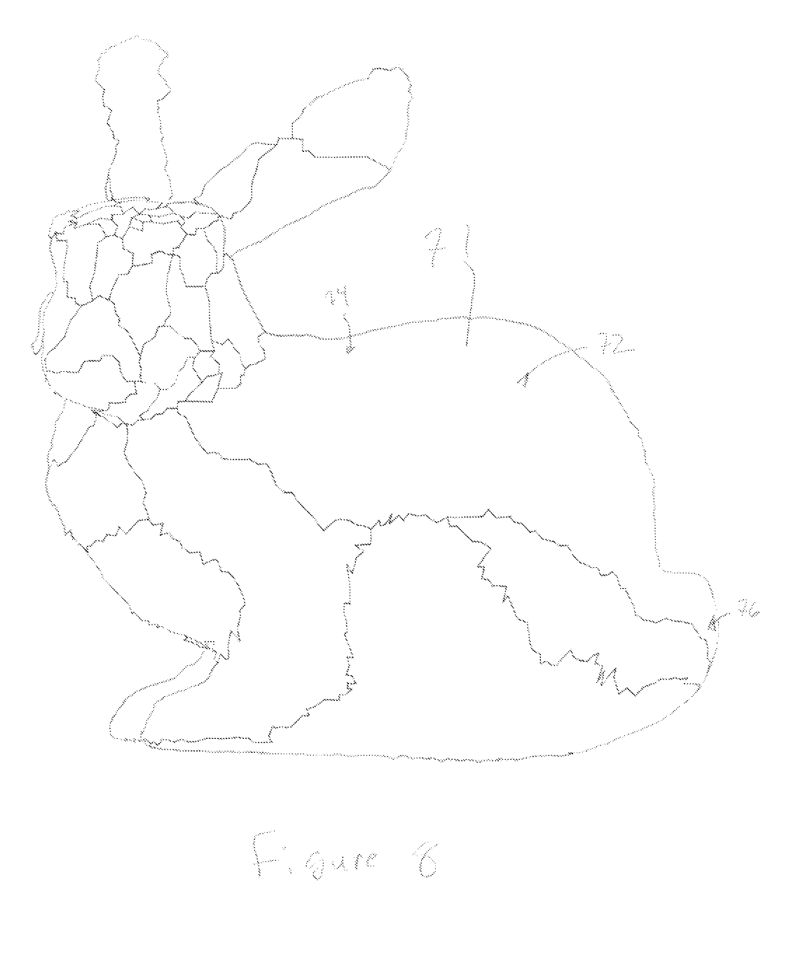

In some embodiments, the seed regions are smoothed with a smoothing algorithm to produce smoother boundaries. FIG. 8 shows the data with the seed regions smoothed. In some embodiments, a minimum path algorithm which has been weighted so as to produce a path close to the original boundary may be used. Other methods may be used to smooth the seed regions 61. In some embodiments the seed regions 61 are not smoothed at this point.

In some embodiments, each of the seed regions of FIG. 7 or 8 are analyzed to determine if they should be further split. For example, it may be preferable that each region is near planar. For example, FIG. 8 shows that seed region 71 has faces 74 and 76 which are in planes which intersect at an angle which is less than, for example, the angle of intersection of the planes of seed geometry 72 and any of the faces adjacent thereto. In some embodiments, if a seed region contains faces which are in planes which intersect with an angle less than a threshold, the seed region is split. In some embodiments, the threshold angle may be, for example, about 175 degrees, about 170 degrees, about 165 degrees, about 160 degrees, about 135 degrees, or about 90 degrees. In some embodiments, comparing the directions of the normal vectors of the faces in the seed region may also be used to determine whether to split the seed region.

It may be preferable that each seed region is nearly parallel with a quadric or other regular surface. In some embodiments, if a seed region contains faces which are not sufficiently parallel with the surface, the seed region is split. As an example, an angle between the normal vector of each geometry of the seed region and a normal vector taken from a point nearest each geometry on the surface is compared with a threshold. In some embodiments, the threshold angle may be, for example, about 10 degrees.

In some embodiments, the seed region to be split is split by placing a second seed geometry in the seed region and generating two seed regions using, for example, a method described above. In some embodiments, the method is performed only on the seed region to be split. Alternatively, the method may be performed on a larger portion of polygonal data 1, or the entire mesh of polygonal data 1.

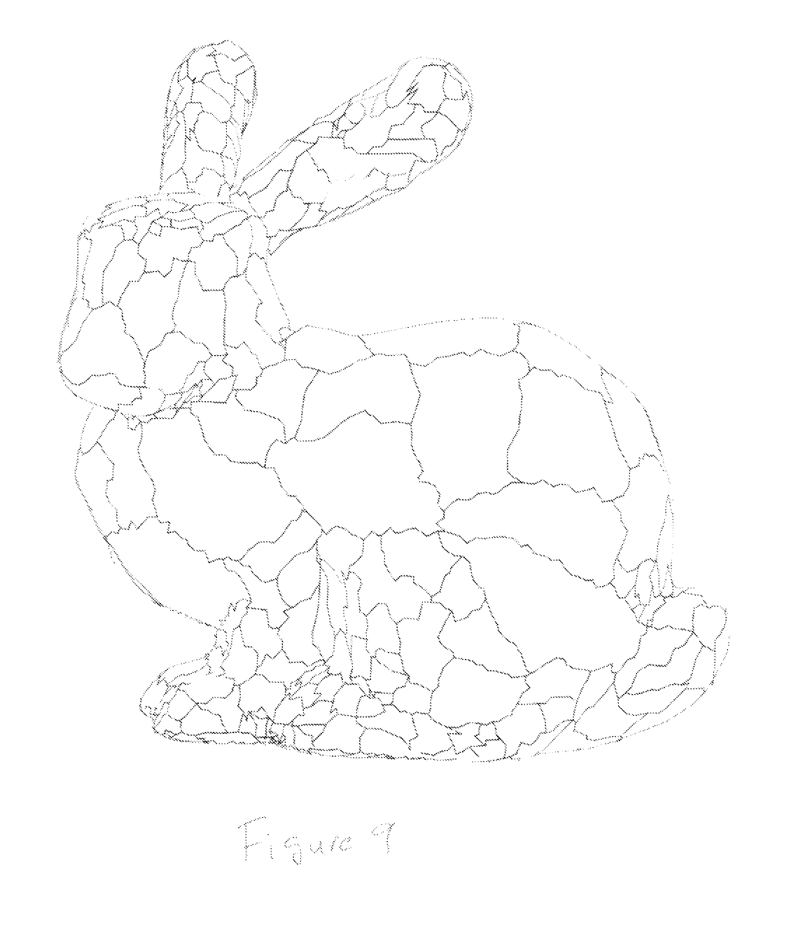

FIG. 9 shows the data where certain seed regions of FIG. 8 have been split. As shown, seed region 71 (as well as other seed regions) has been split to generate multiple seed regions, and the multiple seed regions have been further split based on an analysis such as that described above with reference to FIG. 8. In the embodiment shown in FIG. 9, the seed regions have been smoothed. In some embodiments smoothing is not performed at this point.

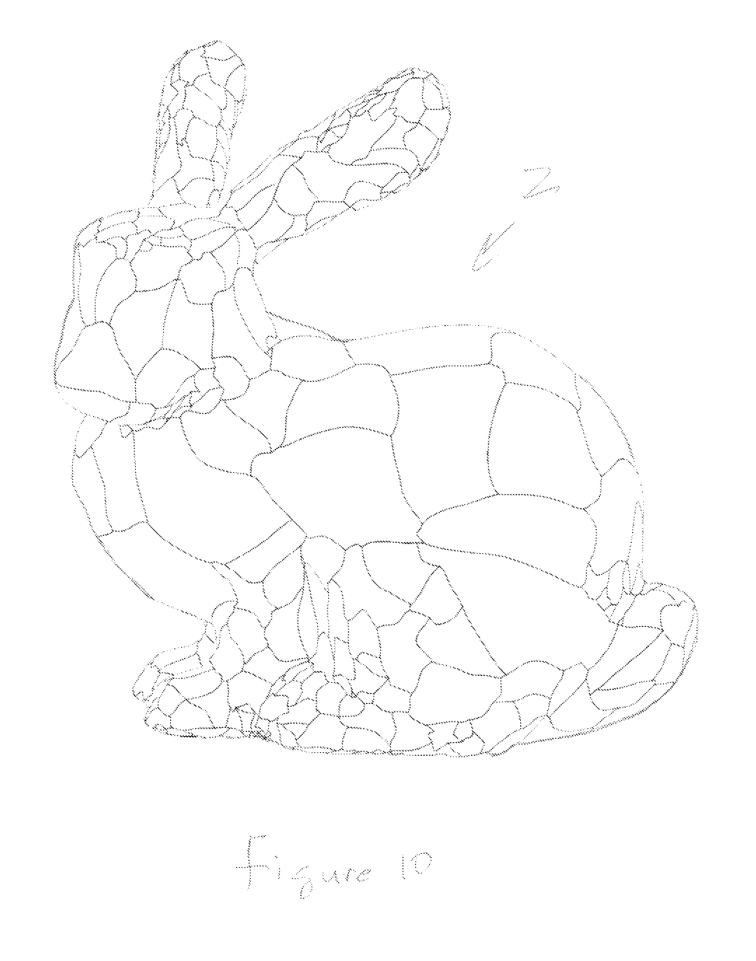

FIG. 10 is a graphical illustration of a continuous BREP object generated from the polygonal data 1 of FIG. 1 based on the boundaries of the seed regions discussed above with reference to FIG. 9. In this embodiment, the edges of the BREP object correspond, at least approximately, with the boundaries of the seed regions of FIG. 9. Any of numerous methods may be used to convert the polygonal data with seed regions to BREP data with surfaces substantially corresponding with the seed regions.

As discussed above, the seed regions start from seed geometries, and are expanded, for example one seed geometry at a time. In some embodiments, the methods and systems repeatedly select a next geometry to include in one of the expanding seed regions. Examples of selecting each next geometry, and examples of assigning the next geometry to one of the seed regions are discussed in more detail below.

In the methods and systems discussed above, the next geometry to include in one of the expanding seed regions is selected from a pool of candidate geometries. In some embodiments, the pool of candidate geometries is made of all of the geometries which are not assigned to a seed region and are adjacent to a seed region.

In some embodiments, multiple parameters P1-PN are determined for each candidate geometry and a weighting factor W1-WN is assigned to each parameter. Candidate geometries are preferred (receive values more likely for selection) or penalized (receive values less likely for selection) based on the values of the parameters and the weighting factors. A value is calculated for each candidate geometry, and the values are compared. The candidate geometry with the most preferred value is selected and added to the seed region to which it is adjacent. As an example, the value for candidate geometry x may be calculated by the following:

Vx=P1*W1+P2*W2+ . . . +PN*WN

Other equations may be used. For example, a non-linear equation, such as a polynomial equation or an exponential equation may be used.

In some embodiments, the parameters include proximity to the seed geometry of the adjacent seed region. For example, a candidate geometry which is closer to the seed geometry of the adjacent seed region may be preferred over a candidate geometry which is farther from the seed geometry of the seed region to which it is adjacent.

The weighting factor for the proximity parameter may, for example, be between about 0.25 and about 0.5. In some embodiments, the weighting factor for the proximity parameter may be fixed. In some embodiments, the weighting factor for the proximity parameter is selectable by a user.

In some embodiments, the parameters include a factor based on how parallel each candidate geometry is with the seed geometry of the adjacent seed region. For example, a seed parallelity value may be calculated, where the seed parallelity value is based on how parallel the normal vector of each candidate geometry is with the normal vector of the seed geometry of its adjacent seed region. Alternatively, the seed parallelity value may be based on how parallel the plane of each candidate geometry is with the plane of the seed geometry of its adjacent seed region.

The weighting factor for the seed parallelity parameter may, for example, be about 1. In some embodiments, the weighting factor for the seed parallelity parameter may be fixed. In some embodiments, the weighting factor for the seed parallelity parameter is selectable by a user.

In some embodiments, the parameters include a factor based on how parallel each candidate geometry is with a surface, for example a quadric or higher order surface fit to the adjacent seed region. For example, a surface parallelity value may be calculated, where the surface parallelity value is based on how parallel the normal vector of each candidate geometry is with a normal vector taken from a point nearest the candidate geometry on a surface fit to the adjacent seed region.

The weighting factor for the surface parallelity parameter may, for example, be about 1. In some embodiments, the weighting factor for the surface parallelity parameter may be fixed. In some embodiments, the weighting factor for the surface parallelity parameter is selectable by a user.

In some embodiments, the parameters include a factor based on how parallel each candidate geometry is with the geometry or geometries which are adjacent to the candidate geometry in the adjacent seed region. For example, a region parallelity value may be calculated, where the region parallelity is based on how parallel the normal vector of each candidate geometry is with the normal vector of the geometry or geometries adjacent to the candidate geometry in the adjacent seed region. Alternatively, the region parallelity value may be based on how parallel the plane of each candidate geometry is with the plane of the geometry or geometries adjacent to the candidate geometry in the adjacent seed region.

The weighting factor for the region parallelity parameter may, for example, be about 1. In some embodiments, the weighting factor for the region parallelity parameter may be fixed. In some embodiments, the weighting factor for the region parallelity parameter is selectable by a user.

In some embodiments, the parameters include a factor based on how smooth or straight the resulting seed region boundary is. For example, a smoothness value may be calculated, where the smoothness value is based on how straight or smooth the boundary or a changing portion of the boundary of the adjacent seed region would be if the candidate geometry is added to the adjacent seed region. For example, the angle itself or a value based on the angle a candidate geometry protrudes into the adjacent seed region may be used as a smoothness value. A candidate geometry having a vertex which protrudes into its adjacent seed region with a narrower angle is preferred over a candidate having a vertex which protrudes into its adjacent seed region with a wider angle.

The weighting factor for the smoothness parameter may, for example, be about between about 0.25 and about 0.5. In some embodiments, the weighting factor for the smoothness parameter may be fixed. In some embodiments, the weighting factor for the smoothness parameter is selectable by a user.

In some embodiments, other parameters are additionally or alternatively used.

The methods and actions described above may be performed by a computer system or a programmable device which accesses instructions for performing the methods and actions stored on a computer readable medium, such as a memory or another data storage device. The instructions, when executed by the computer system, cause the methods and actions to be performed. The polygonal data may be generated with a computer CAD system and may be stored in a non-transitory computer readable medium, such as a memory or data storage device. The computer system, configured to perform or to be used to perform the methods and actions described above, accesses the polygonal data to perform the methods and actions. Once data representing the BREP object is generated, the data may be stored in a non-transitory computer readable medium, such as a memory storage device. The data may be used to generate an electronic or printed image of the continuous BREP object. The data may also be used to generate a physical representation or instructions for generating a physical representation of the continuous BREP.

The various aspects, processes, actions may be performed sequentially or in parallel. For example, a system capable of parallel processing may divide certain procedures among the available processing devices.

While various aspects, processes, actions, and systems have been described as being included in the embodiments discussed, the various aspects, processes, actions, and systems can be practiced with certain modifications. For example, the sequential order of the various aspects, processes, and actions may be modified. In addition, certain aspects, processes, and actions may be omitted, and other aspects, processes, and actions may be added.

What is claimed is:

1. A method of producing BREP data from electronic polygonal data, the method comprising:
accessing the polygonal data with a computer, the polygonal data defining a mesh comprising a plurality of geometries;
designating some of the geometries as seed geometries;
defining a plurality of seed regions, each containing one of the seed geometries;
expanding the seed regions so that each of the geometries of the mesh are included in one of the seed regions;
generating the BREP data based at least in part on the seed regions; and
storing the BREP data in a computer readable data storage.

2. The method of claim 1, wherein designating some of the geometries as seed geometries comprises determining a number of seed geometries and adjusting the number of seed geometries.

3. The method of claim 2, wherein determining the number of seed geometries comprises dividing the number of geometries in the mesh by a constant.

4. The method of claim 2, wherein adjusting the number of seed geometries comprises:
generating a plurality of seed regions and determining an angle between the geometries of each seed region with either the plane of the seed geometry of the seed region or a tangential plane of a surface fit to the seed region;
based on the determined angles, determining whether an average angle is greater than a threshold;
increasing the number of seed geometries if the angle is greater than the threshold; and
decreasing the number of seed geometries if the angle is less than the threshold.

5. The method of claim 4, wherein determining the angle between the seed geometry of each seed region and the other geometries of each seed region comprises determining an angle between normal vectors of the seed geometries and normal vectors of the other geometries of each seed region.

6. The method of claim 1, wherein expanding the seed regions comprises repeatedly selecting a next geometry to include in one of the seed regions.

7. The method of claim 6, wherein selecting the next geometry includes calculating a value for each of a plurality of candidate geometries and selecting the most preferred geometry based on a comparison of the values.

8. The method of claim 7, wherein the values are calculated based on a plurality of weighted parameters.

9. The method of claim 8, wherein the weighted parameters include a proximity parameter based on proximity to the seed geometry of the adjacent seed region.

10. The method of claim 9, wherein the weighting factor of the proximity parameter is between about 0.25 and about 0.5.

11. The method of claim 8, wherein the weighted parameters include a seed parallelity parameter based on how parallel each candidate geometry is with the seed geometry of the adjacent seed region.

12. The method of claim 11, wherein the weighting factor of the seed parallelity parameter is about 1.

13. The method of claim 8, wherein the weighted parameters include a surface parallelity parameter based on how parallel the normal vector of each candidate geometry is with a normal vector taken from a point nearest the candidate geometry on a surface fit to the adjacent seed region.

14. The method of claim 13, wherein the weighting factor of the surface parallelity parameter is about 1.

15. The method of claim 8, wherein the weighted parameters include a region parallelity parameter based on how parallel each candidate geometry is with the geometry or geometries which are adjacent to the candidate geometry in the adjacent seed region.

16. The method of claim 11, wherein the weighting factor of the region parallelity parameter is about 1.

17. The method of claim 8, wherein the weighted parameters include a smoothness parameter based on how smooth a resulting seed region boundary is.

18. The method of claim 17, wherein the weighting factor of the smoothness parameter is between about 0.25 and about 0.5.

19. The method of claim 1, further comprising:
designating a plurality of geometries as new seed geometries;
defining a plurality of new seed regions, each containing one of the new seed geometries;
expanding the new seed regions so that each of the geometries of the mesh are included in one of the new seed regions.

20. The method of claim 19, wherein designating the plurality of geometries as new seed geometries comprises selecting center geometries of the seed regions as new seed geometries.

21. The method of claim 1, further comprising smoothing the boundaries of the seed regions.

22. The method of claim 1, further comprising determining to split at least one of the seed regions, and splitting the at least one seed region.

23. The method of claim 22, wherein splitting the at least one seed region comprises:
selecting another seed geometry in the region;
defining first and second seed regions within the at least one seed region, wherein each of the first and second seed regions includes one of the seed geometries;
expanding the first and second seed regions so that each of the geometries of the at least one seed region are included in either the first or second seed region.
